(19) United States
(12) Patent Application Publication
(10) Pub. No.: US 2011/0004598 A1
(43) Pub. Date: Jan. 6, 2011

(54) SERVICE RESPONSE PERFORMANCE ANALYZING DEVICE, METHOD, PROGRAM, AND RECORDING MEDIUM CONTAINING THE PROGRAM

(75) Inventor: Shinji Kikuchi, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 12/736,027

(22) PCT Filed: Mar. 25, 2009
(86) PCT No.: PCT/JP2009/055906

§ 371 Date: Sep. 2, 2010

(30) Foreign Application Priority Data
Mar. 26, 2008 (JP) 2008-081000

(51) Int. Cl. G06F 17/30

(52) U.S. Cl. 707/741; 707/E17.002; 707/E17.012

(57) ABSTRACT

A device for analyzing service response performance, a method and a program which can take action with high immediacy according to the communication state between a service provider's terminal and a service requester's terminal, and a recording medium containing the program are provided.

The device for analyzing service response performance 100 includes an analyzing unit 116 which determines whether a communication message violates items defined as SLA information managed by the SLA managing unit 115 and detects and identifies an expression form in the communication message which causes the violation, a fact managing unit 117 which manages the expression form causing violation as a fact, a stream analyzing unit 102 which determines whether a fact corresponding to causing a violation against the items defined as SLA information exists or not by scanning expression forms included in a communication message which circulates between terminals of both of a service provider and a terminal of a service requester, and a fact index generating unit 104 that generates a fact index which is used at the time of scanning by the stream analyzing unit 102.

### TECHNICAL FIELD

The present invention relates to a device and a method to be used under an environment where plural service providers and plural service requesters communicate. The present invention also relates to a device and a method which observe, analyze, calculate and estimate items defined as SLA (Service Level Agreement) information which indicate service providing conditions decided between a service provider concerned and plural service requesters, in order to calculate such items of information.

The present invention also calculates such items defined as SLA information, those are extracted with linkage on expression forms of a communication message, holds and updates it in order to use and leverage it, and in addition, scans expression forms included in a communication message which circulates between any service provider and any service requester. The present invention also relates to a device and a method which determine whether the items defined as SLA information which specify service providing conditions is violated or not promptly or immediately.

### BACKGROUND ART

Technology which judges whether a communication message circulating between any service provider and any service requester relates to violations on the items defined as SLA information which specify service providing conditions or not by using a mining technology and a stream analysis technology is being proposed. For such a technology, multi-steps process as disclosed in a patent document 1 is needed.

For example, in the method of the above-mentioned patent document 1, as the first step, it is required to collect workflow definitions stored in plural distributed workflow monitor systems, then also to capture the outline of the whole process preliminarily.

After that, in the method of the above-mentioned patent document 1, as the second step, it is necessary to comprehend actual behaviors of the messages by capturing events related to these messages, and then to store and maintain these histories.

Finally, in the method of the above-mentioned patent document 1, as the third step, desired information are obtained by starting batch processes which perform statistical processing and evaluation processing based on the behaviors of the messages which have been stored and maintained.

In a patent document 2, there is also disclosed the technology which monitors services to be maintained with the specified level of SLA, and warns when it is violated.

[Patent document 1] Japanese Patent Application Laid-Open No. 2007-257513

[Patent document 2] Japanese Patent Application Laid-Open No. 2005-92886

### DISCLOSURE OF THE INVENTION

### Technical Problems

It is difficult to take an action with high immediacy in response to communication states, because the processing will take a longer time if the multi-steps process is applied as mentioned in the patent document 1.

In addition, the invention disclosed by the patent document 2 specifies a structure in which a server as a provider of service and a client as requester of the service are under connection via a network. For this reason, in the invention disclosed by the patent document 2, there is neither a disclosure nor even a suggestion about the structure for capturing a message circulating between such the server and the client. That is, in invention disclosed by the patent document 2, it is not possible to monitor whether services are maintained with the specified level of SLA or not based on the communication state between the server and the client.

The present invention has been made in order to solve these problems. Objects of the present invention are to provide a device, a method, a program, and a recording medium that contains the program for analyzing the service response performance and also for taking highly immediate actions in response to communication states with both terminals of the service provider and the service requester.

### Solution to the Problems

In order to achieve the above-mentioned objects, under an environment where plural terminals between both arbitrary service providers and arbitrary service requesters communicate, as a first aspect, the present invention provides a device for analyzing service response performance, which includes following six elements;

SLA managing means for managing items defined as SLA information which specify service providing conditions decided between an arbitrary service provider and an arbitrary service requester;

message capturing means for capturing all communication messages which circulate between terminals of both of the arbitrary service provider and arbitrary service requester;

analyzing means not only for determining whether a communication message which the mentioned message capturing means has captured relates to violations on the items defined as SLA information managed by the mentioned SLA managing means or not, but also for detecting and identifying an expression form in the communication message which causes a violation, when the violation happens;

fact managing means for managing the violation-causing expression form detected and identified by the mentioned analyzing means as a fact;

stream analyzing means for determining whether a fact corresponding to causing a violation against the items defined as SLA information exists or not by scanning the expression form included in the communication message which circulates between terminals of both of the arbitrary service provider and the arbitrary service requester; and

fact index generating means for receiving a series of facts from the mentioned fact managing means, and generating a fact index which the mentioned stream analyzing means uses in order to perform processing of the scanning at a high speed.

Also in order to achieve the above-mentioned objects, under an environment where plural terminals between both arbitrary service providers and arbitrary service requesters communicate, as a second aspect, the present invention provides, a program not only for analyzing a service response performance for letting an information processing apparatus implemented between terminals of both of the arbitrary service provider and the arbitrary service requester analyze service response performance, but also for making a computer which substantially controls the mentioned information processing apparatus function, and including following six elements;
SLA managing means for managing items defined as SLA information which specify service providing conditions decided between the arbitrary service provider and the arbitrary service requester;
message capturing means for capturing all communication messages which circulate between terminals of both of the arbitrary service provider and arbitrary service requester;

an analyzing means not only for determining whether a communication message which the mentioned message capturing means has captured relates to violations on the items defined as SLA information managed by the mentioned SLA managing means or not, but also for detecting and identifying an expression form in the communication message which causes a violation, when the violation happens;

fact managing means for managing the violation-causing expression form detected and identified by the mentioned analyzing means, as a fact;

stream analyzing means for determining whether a fact corresponding to causing a violation against the items defined as SLA information exists or not by scanning the expression form included in the communication message which circulates between terminals of both of the arbitrary service provider and the arbitrary service requester; and

fact index generating means for receiving a series of facts from the mentioned fact managing means, and generating a fact index which the mentioned stream analyzing means uses in order to perform processing of the scanning at a high speed.

Also in order to achieve the above-mentioned objects, as a third aspect, the present invention provides a recording medium that stores the mentioned program for analyzing service response performance which is specified as the second aspect of the present invention.

Also in order to achieve the above-mentioned objects, under an environment where plural terminals between both arbitrary service providers and arbitrary service requesters communicate, as a fourth aspect, the present invention provides a method for analyzing a service response performance, by which the information processing apparatus:

manages items defined as SLA information which specify service providing conditions decided between the arbitrary service provider and the arbitrary service requester;

captures all communication messages which circulate between terminals of both of the arbitrary service provider and the arbitrary service requester;

determines whether a communication message which has been captured relates to violations on the items defined as SLA information which are managed or not, and detects and identifies an expression form in the communication message which causes the violation when the violation happens;

manages the violation-causing expression form detected and identified as a fact;

determines whether a fact corresponding to causing a violation against the items defined as SLA information exists or not by scanning the expression form included in the communication message which circulates between terminals of both of the arbitrary service provider and the arbitrary service requester; and

receives facts, and generates a fact index in order to perform processing of the scanning at a high speed.

### ADVANTAGEOUS EFFECTS OF THE INVENTION

According to the present invention, a device for analyzing service response performance, a method and a program which can take an action with high immediacy in response to a state of communication between terminals of both of a service provider and a service requester, and a recording medium containing the mentioned program can be provided.

### Description of Embodiments

As shown in FIG. 1, under an environment where plural terminals of both of arbitrary service providers and arbitrary service requesters communicate, a device for analyzing service response performance 100 specified by the present invention is characterized by including:

a SLA managing unit 115 which manages items defined as SLA information specifying service providing conditions decided between an arbitrary service provider and an arbitrary service requester;

a message capturing unit 101 which captures all communication messages which circulate between terminals of both of an arbitrary service provider and an arbitrary service requester;

an analyzing unit 116 that determines whether a communication message captured by the mentioned message capturing unit 101 is in violation with the items defined as SLA information managed by the mentioned SLA managing unit 115 or not, and when violating, detects and identifies an expression form in the communication message which causes the violation;

a fact managing unit 117 which manages the violation-causing expression form detected and identified by the mentioned analyzing unit 116 as a fact;

a stream analyzing unit 102 which determines whether a fact in violation with the items defined as SLA information exists or not by scanning expression forms included in communication messages which circulate between terminals of both of an arbitrary service provider and a terminal of an arbitrary service requester; and

a fact index generating unit 104 that receives a series of facts from the mentioned fact managing unit 117 and generates a fact index which the mentioned stream analyzing unit 102 uses in order to perform processing of scanning at high speed.

By configured as mentioned above, the mentioned the device for analyzing service response performance 100 can generate a fact index for using in determination, whether service providing conditions are satisfied or not, by using messages circulating between both of plural service providers and plural service requesters. When determining whether the items defined as SLA information which specify service providing conditions is violated or not, by scanning expression forms included in a communication message which circulates between both of a service provider and a service requester and by using the fact index, it becomes possible for the device for analyzing service response performance 100 to determine whether the items defined as SLA information specifying service providing conditions is violated or not promptly or immediately.

Hereinafter, the preferred embodiment of the present invention will be described.

A structure of a service response performance analyzing system according to the preferred embodiment of the present invention is shown in FIG. 2. This system is applied to an environment in which plural service providers and plural service requesters communicate. In this system, service execution servers 8, 9 and 10 and service calling clients 6 and 7 have a service call relationship 41 decided between the service provider and the service requester in advance. The system communicates using XML (eXtensible Markup Language), and there exist a proxy unit 1 placed between the service providers and the service requesters.

The device for analyzing service response performance 0 based on Content-Aware has the proxy unit 1. The proxy unit 1 (the device for analyzing service response performance 0) captures all communication message groups (hereinafter, called XML-Msg group) 18 and 18′ which circulate between the service execution servers 8, 9 and 10 and the service calling clients 6 and 7.

As shown in FIG. 3, a part of the device for analyzing service response performance 0 except for the proxy unit 1 is roughly divided into two parts.

One is the part which calculates the items defined as SLA information defined on the service call relationship 41. This part captures, observes, analyzes and estimates all XML-Msg groups 18 and 18′ circulating. Then, this part calculates the items defined as SLA information based on relation with an expression form of an XML-Msg, and holds and updates the information in order to use and leverage it. This part includes an activation unit 12, an analysis time managing unit 13, an exchanged Msg managing unit 14, an analysis module 16, a SLA managing unit 15 and a fact managing unit 17.

The other is the part which immediately determines whether the items defined as SLA information are violated or not. This part captures all XML-Msg groups 18 and 18′ which circulate between the service execution servers 8, 9 and 10 and the service calling clients 6 and 7 defined on the service call relationship 41, and scans expression forms included in the XML-Msg. The part includes a stream analyzing unit 2, a fact index unit 4, a development unit 5 and a warning unit 3.

As a result of scanning, when the items defined as SLA information are violated, a warning message 19 is issued from the warning unit 3 immediately to a service operations manager 11.

When all XML-Msg groups 18 and 18′ circulating are captured, in parallel with performing scanning, the proxy unit 1 stores all captured XML-Msg groups in the exchanged Msg managing unit 14 once. In the exchanged Msg managing unit 14, a set of time when each of the XML-Msg groups 18 and 18′ has passed the proxy unit 1 and address information of the service execution servers 8, 9 and 10 and the service calling clients 6 and 7 corresponding to the caller and the call destination of each of the XML-Msg groups 18 and 18′ is held along with the XML-Msg body. The form of address information is discretionary. The proxy unit 1 corresponds to the message capturing unit 101 in FIG. 1.

The SLA managing unit 15 manages the items defined as SLA information. In the management, address information on the service execution servers 8, 9 and 10 and the service calling clients 6 and 7 corresponding to the caller and the call destination which identifies the service call relationship 41 is used. Although the form of the address information is discretionary, it should be a form that is not inconsistent with the exchanged Msg managing unit 14, the fact managing unit 17, the fact index unit 4 and an analysis module unit 16. The SLA managing unit 15 corresponds to the SLA managing unit 115 in FIG. 1.

The items defined as SLA information include a total response time spent until each of the service calling clients 6 and 7 which are service requesters receive the XML-Msg representing a service reply for the XML-Msg representing a service request issued to the service execution servers 8, 9 and 10 that are service repliers. Also, the items defined as SLA information include the size, the frequency of occurrence, a syntax error of the XML-Msg and the like.

Because the items defined as SLA information are generally defined individually on the service call relationship 41, other particular exceptions may be included.

The activation unit 12 defines and controls a designated time period for performing analysis, and in addition to that, activates the analysis module unit 16 periodically according to the period. In regards to methods of activation, there are various methods such as a program activation/calling by an application program and activation by a message, and any method may be used.

The analysis time managing unit 13 measures a one-time processing time of the analysis module unit 16. This is a time period from a point when the activation unit 12 is activated by the analysis module unit 16 to a point when the analysis module unit 16 is ended.

According to need, the analysis time managing unit 13 adjusts a time interval of the activation unit 12 for activating the analysis module unit 16. Alternatively, as mentioned later, by increasing and decreasing the number of registrations to a list of XML-Msg groups when creating the list (the number of registrations to a list in Step S111 of FIG. 8), and the number of divisions of a Xpath vector representation (the division number in Step S214 of FIG. 9), the analysis time managing unit 13 adjust processing of the analysis module unit 16 so that it may complete within a desirable time period. By the above, the device for analyzing service response performance 0 can maintain a degree of freshness about fact data which becomes a basis of accuracy of immediate determination for scanning performed by the stream analyzing unit 2. As a result, the device for analyzing service response performance 0 according to this exemplary embodiment can maintain accuracy of immediate determination at high level.

The analysis module unit 16 obtains all XML-Msg groups 18 and 18′ which have passed the proxy unit 1 within a designated time period from the exchanged Msg managing unit 14 as well as sets of time when passing the proxy unit 1 and address information, and in addition, obtains the items defined as SLA information from the SLA managing unit 15. Then, after having analyzed all the XML-Msg groups 18 and 18′, the analysis module unit 16 calculates and identifies a case that violates the items defined as SLA information based on relation with an expression form of the XML-Msg, and defines it as a fact. On this occasion, the analysis module unit 16 uses a main procedure of analysis and estimation shown in FIG. 8, a main procedure of correlation calculation shown in FIGS. 9 and 10 and a subroutine procedure of correlation calculation shown in FIG. 11. Then, the analysis module unit 16 outputs the fact to the fact managing unit 17. The analysis module unit 16 corresponds to the analyzing unit 116 in FIG. 1.

The fact managing unit 17 manages and maintains facts, in order to use and leverage these facts which the analysis module unit 16 has estimated and defined. Each of the fact is also referred to during processing of the analysis module unit 16. The fact managing unit 17 corresponds to the fact managing unit 117 in FIG. 1.

All facts managed by the fact managing unit 17 are developed by the development unit 5 to the fact index unit 4. To do so, the fact managing unit 17 transmits update information 42 to the development unit 5. After that, the development unit 5 updates the fact index unit 4.

When all XML-Msg groups 18 and 18′ circulating are captured, the proxy unit 1 carries out scanning. The scanning is performed by the stream analyzing unit 2. The stream analyzing unit 2 refers to the fact index unit 4 at the time of the scanning. This procedure is shown in FIG. 4. The stream analyzing unit 2 corresponds to the stream analyzing unit 102 in FIG. 1. The fact index unit 4 corresponds to the fact index generating unit 104 in FIG. 1.

As a result of the scanning, when there exists an expression form on the XML-Msg which is registered with the fact index unit 4, although the cause is not clear, it is handled as a violation because violation of the items defined as SLA information have been estimated and observed before. Accordingly, the stream analyzing unit 2 calls the warning unit 3.

After that, the warning message 19 is issued from the warning unit 3 to the service operations manager 11 immediately.

In order to configure the fact managing unit 17 and the fact index unit 4 or in order to refer to the fact index unit 4, expression conversion of XML-Msg groups 18 and 18′ is needed. FIG. 5 is a diagram showing a conversion process carried out in the analysis module unit 16 or a conversion process performed at the time of scanning.

A general example of any instance of XML-Msg groups 18 and 18′ which circulates is described as the XML-Msg 43 in FIG. 5. This is solely an example and is not limited to a specific form.

The XML-Msg 43 can be expressed like an equivalent Xpath graphic expression 20. In the equivalent Xpath graphic expression 20, a data content of an XML element are expressed in a leaf symbol 39 of a double-lined oval meaning a leaf expression. A node expression leading to the leaf expression is expressed in a node symbol 38 of a solid line oval.

When the XML-Msg 43 has data contents of a plurality of XML elements in the same Xpath, the node symbol 38 has, as order of appearance, serial numbers of no smaller than one such as [1] and [2] in the interior to identify each of them. Relational combination of two of the node symbol 38s and relational combination of the node symbol 38 and the leaf symbol 39 is expressed by a link symbol 37.

The XML-Msg 43 which has been captured by the analysis module unit 16 or the stream analyzing unit 2 is converted into a form like the equivalent Xpath graphic expression 20, and then converted into an equivalent Xpath expression 21.

The equivalent Xpath expression 21 includes plural record groups. One element record of the plural record groups is expressed as a new character string 40 which occurs by connecting:

absolute position information on a Xpath graph specified by the equivalent Xpath graphic expression 20;

a character string ‘>″’ which means a delimiter separation symbol;

a value obtained by performing character string conversion of the data contents of the XML element specified by absolute position information on the Xpath graph;

a synthetic character string according to a type information symbol; and

a character string ‘″’ which means a delimiter separation symbol, in turn.

The character string converted part of the data contents of an XML element which the equivalent Xpath expression 21 has is expressed by the character string converted data. In particular, in the case of a numerical data, the character string converted part is converted to a corresponding hexadecimal expression. In the case of a general binary data, the character string converted part concerned is expressed being converted to the character string by Base 64 encoding so on.

The type information symbol which the equivalent Xpath expression 21 has is expressed by a form that can uniquely specify the data format before the conversion. In FIG. 5, although the character string is being expressed by ‘(String)’ or so on, if a requirement that the data format before the conversion can be uniquely specified is satisfied, it may be expressed by the other format.

In registration of a fact performed by the analysis module unit 16, the conversion as shown in FIG. 6 is further carried out. A special B-Tree structure 44 defined in FIG. 6 (b) is defined to both of the fact index unit 4 and the fact managing unit 17. As a result of the conversion process of FIG. 5, by using a character string about a specific Xpath graph absolute position information positioned before the character string ‘>″’, which means the delimiter separation, from the character string 40 generated newly, the special B-Tree structure 44 that is a subspecies of B-Tree is composed.

There is no large difference between a general B-Tree structure and a basic structure of the special B-Tree structure 44. However, because a character string about an absolute position of the specific Xpath graph is absolute position information, it includes route information on a node hierarchy leading to a node, and thus it has a redundant structure. Therefore, in the portions 46 and 47 on the B-Tree, it is structured such that a part having the same character string as the parent node 46 is omitted from description of the child node 47. Further, about a serial number such as [1] and [2] for controlling order of appearance for multiple appearances of data contents of an XML element on a same level Xpath defined on the equivalent Xpath graphic expression 20, it is generalized and expressed by a wildcard [*].

From the above, the character string “/E21 [1]/E31 [*]” expressed at the child node 47 in FIG. 6 corresponds to, by rights, “/root/E11/E21 [1]/E31 [*]”, and as a specific example of the expression, the character strings such as “/root/E11/E21 [1]/E31 [1]” and “/root/E11/E21 [1]/E31 [1000]” fall under the category.

About the value which is made by performing character string conversion of data contents of the XML element positioned after the character string ‘>″’, which means the delimiter separation symbol, from the character string 40 generated newly as a result of the conversion process of FIG. 5, and about a synthetic character string according to the type information symbol, because they are managed by a different data structure, a starting-point pointer which is the reference destination thereof is indicated on leaf description 25.

FIG. 7 is a diagram showing a schematic configuration of the fact index unit 4. The fact index unit 4 is provided in order to make the stream analyzing unit 2 carry out scanning process at high speed. The fact index unit 4 is formed by a combination of three index structures. The first one is a XML-Msg type index 23. The second one is XML-Msg structure indexes 22, 22′ and 22″ having the special B-Tree structure 44. And the third one is designation data indexes 24 and 24′ having a B-Tree structure.

The XML-Msg type index 23 is configured by a hash table (Hash Table), and a bucket of the hash is defined according to NameSpace of the XML Schema corresponding to the type information of all XML-Msg groups 18 and 18′ circulating. In each bucket, the service call relationship 41 which uses the XML-Msg groups 18 and 18′ of that the type information is managed as a list. The each includes: a combination of address information of a caller and address information of the call destination; and a starting-point pointer which is the call destination of the XML-Msg structure indexes 22 and 22′, 22″.

When the type information of the XML-Msg groups 18 and 18′ is different, there is a case where a different XML-Msg structure index is referred to. For this reason, a plurality of the XML-Msg structure indexes 22 and 22′, 22″ will be also existed.

It is expected that the fact index unit 4 consumes a memory on a large scale, and also it needs to be processed at a high speed. In the XML-Msg type index 23, the fact index unit 4 has the structure mentioned above in order to perform handling such as swapping in and swapping out the whole of each the XML-Msg structure indexes 22 and 22′, 22″ according to the type information of the XML-Msg groups 18 and 18′.

Each of the XML-Msg structure indexes 22 and 22′, 22″ is configured having the same structure as the special B-Tree structure 44 shown in FIG. 6 (b). Its leaf description includes: a value which is made by performing character string conversion of data contents of the XML element positioned after the character string ‘>″’, which means the delimiter separation symbol, in the character string included in an equivalent Xpath expression; and a starting-point pointer which is a reference destination to the designation data indexes 24 and 24′ that manages a synthetic character string according to the type information symbol.

Accordingly, a plurality of the designation data indexes 24 and 24′ exist. The designation data indexes 24 and 24′ have a B-Tree structure, respectively. The designation data indexes 24 and 24′ manages: a value which is made by performing character string conversion to a value of an element and an attribute value which are the data contents of each XML element; and a synthetic character string according to the type information symbol. Usually, one designation data index is assigned according to each element and each attribute value.

Based on the above, a node hierarchy 45 and a leaf description 26 are configured including a synthetic character string. When these values are designated, it means that violation of the items defined as SLA information are estimated and observed. In particular, when a plurality of values are defined in the leaf description 26, it means that different values are designated at an absolute position of a same specific Xpath graph among the XML-Msg groups 18 and 18′ and the each can violate the items defined as SLA information.

Meanwhile, as mentioned above, the leaf description 26 manages: a value which is made by performing the character string conversion to an element and to an attribute value which are data contents of each XML element; and the synthetic character string according to the type information symbol. There is a case where the leaf description 26 includes huge data to which encoding has been performed, and in such case, it is possible to perform management using a digest value.

In the leaf description 26, there exists a case in which co-occurrence conditions description 27 is included. In this case, the co-occurrence conditions description 27 refers to the leaf description 25. This means that a phenomenon which can violate the items defined as SLA information is not determined only by one condition. And, this means that an arbitrary fixed value is designated for absolute position information of a different specific Xpath graph, and a phenomenon which can violate the items defined as SLA information occurs under combined conditions.

Operation will be described focusing on the analysis module unit 16 and the stream analyzing unit 2.

FIG. 8 is a flow chart showing the main procedure of analysis and estimation carried out by the analysis module unit 16. FIGS. 9 and 10 are flow charts showing the main procedure of correlation calculation called from the main procedure of analysis and estimation in the analysis module unit 16. FIG. 11 is a flow chart showing a subroutine procedure called from the main procedure of correlation calculation in the analysis module unit 16.

When the analysis module unit 16 is activated by the activation unit 12, all XML-Msg groups 18 and 18′ which have passed the proxy unit 1 during a designated time period as well as a set of time when passing the proxy unit 1 and address information are obtained from the exchanged Msg managing unit 14 (Step S101).

After that, the analysis module unit 16 classifies the XML-Msg groups 18 and 18′ according to address information on a caller and address information on the call destination which are the service call relationship 41, and to NameSpace of the XML Schema corresponding to type information of the XML-Msg groups 18 and 18′ which is a type of a message (Step S102).

Then, the analysis module unit 16 acquires one classification which has not been processed yet among XML-Msg groups 18 and 18′ (Step S103).

After that, the analysis module unit 16 determines whether it has been already registered with the fact managing unit 17 based on the service call relationship 41 of the classification selected in Step S103 (Step S104).

When it has been already registered and, in addition, correction is not needed about the fact of this classification (Step S105/Yes and S106/not needed), the analysis module unit 16 returns to the processing of Step S103.

On the other hand, when it has already been registered, but correction is needed about the fact of the classification (Step S105/Yes and S106/needed), or when it has not been registered with the fact managing unit 17 yet (step S105/No), the analysis module unit 16 advances to processing of Step S107.

Then, the analysis module unit 16 searches for and obtains the items defined as SLA information which indicate service providing conditions defined on the service call relationship 41 from the SLA managing unit 15. After that, the analysis module unit 16 sorts the XML-Msg groups 18 and 18′ belonging to the classification selected in Step S103 by organizing and processing them based on the items defined as SLA information (Step S107).

Subsequently, the analysis module unit 16 performs evaluation about a value which least meet the designated the items defined as SLA information among the XML-Msg groups 18 and 18′ that have been sorted, and identifies that XML-Msg 13. Then, the analysis module unit 16 reserves it in another area for subsequent processing (Step S108).

The analysis module unit 16 repeats Steps S103 to S108 until all classifications of the XML-Msg groups 18 and 18′ classified in Step S103 are processed. When all classifications are processed (step S109/Yes), processing is advanced to Step S110.

After that, the analysis module unit 16 merges a series of XML-Msg 43 groups least meeting the items defined as SLA information on each service call relationship 41 which have been reserved in another area in Step S106. Then, the analysis module unit 16 sorts it in descending order from the XML-Msg 43 with the highest degree of not meeting the items defined as SLA information (Step S110).

After that, the analysis module unit 16 takes out a predetermined number of the XML-Msg 43s starting from the first value of the series of the XML-Msg 43 groups sorted and creates a list of the XML-Msg 43s (Step S111). About such a predetermined number, it is designated by the analysis time managing unit 13. This is because, the degree of freshness about data of a fact which becomes a accuracy basis of immediate determination for scanning which the stream analyzing unit 2 carries out depends indirectly on the processing capacity that the analysis module unit 16 has. It is possible to make the designated time period related to an activation of the analysis module unit 16 be a short period by decreasing such predetermined number.

Meanwhile, regarding a classification which is not described on the list, there is a high possibility to become an evaluation target because it will be placed at a higher position in a series of the XML-Msg 43 groups not meeting the items defined as SLA information during a designated time period of next time or later.

After that, the analysis module unit 16 takes out one of the XML-Msg 43s that has not been processed yet from the list (Step S112).

Following this, for the selected XML-Msg 43, the analysis module unit 16 identifies and extracts a related fact using the main procedure of correlation calculation shown in FIGS. 9 and 10, the subroutine procedure shown in FIG. 11 and the like (Step S113).

Subsequently, only when the identified and extracted fact exists, the analysis module unit 16 registers it with the fact managing unit 17 (Step S114).

When processing for all XML-Msg 43s on the list is completed (step S115/Yes), the analysis module unit 16 advances towards Step S116, and in other cases (step S115/No), returns to Step S112 in order to process next XML-Msg 43.

The analysis module unit 16 enters a dormant state (Step S116) until there is a restart request for the next designated time period.

A main procedure of correlation calculation shown in FIGS. 9 and 10 is called in Step S113. The analysis module unit 16 treats the XM1-Msg 43 taken out in Step S112 as a message to be referred to (Step S201). Then, according to XML Schema corresponding to type information which the XML-Msg 43 refers to, the analysis module unit 16 obtains a Xpath vector expression M(s)_{k=0,1=1} which takes: absolute position information on all Xpath graphs as a component; and a value which is made by performing character string conversion on a value of an element and an attribute value included in the XML-Msg 43 as a component value expressed in hexadecimal. For this reason, the whole of the XML-Msg 43 is designated to be converted to Unicode and so on. Character strings so on are also mapping-transformed as a numerical value with a carry according to the corresponding hexadecimal number.

In this case, because MaxOccurs is not designated on XML Schema, there exists a case where the number of appearances is indeterminate.

For this reason, in a maximum appearance vector expression for all numerical values of indeterminate appearance counts, one component is designated certainly from the XML-Msg groups 18 and 18′ that belong to a classification selected in Step S103 beforehand, and its component value is treated as 0.

In Xpath vector expression M(s)_{k=0, 1=1}, the variable s means that it is reference. The variable k means the number of times of division, and the variable 1 means a divided element ordinal number. Because Step S201 is an initial stage, “0” is assigned to the variable k, and “1” is assigned to the valuable 1.

The analysis module unit 16 takes out only pieces of information required for evaluation from the items defined as SLA information about the XML-Msg 43 that is a reference message, and obtains a vector S (s) which includes it as components (Step S202).

The analysis module unit 16 takes out the XML-Msg groups 18 and 18′ which have passed the proxy unit 1 during a designated time period from the exchanged Msg managing unit 14 and which have caller address information, call destination address information and a message type which are the same service call relationship 41 as that of the XML-Msg 43 which is the reference message (Step S203).

After that, the analysis module unit 16 calls a subroutine for correlation calculation shown in FIG. 11 (Step S204). On this occasion, the XML-Msg groups 18 and 18′ obtained in Step S203 is handed to the subroutine.

Then, the analysis module unit 16 counts the number of the XML-Msg groups 18 and 18′ up (Step S241). Variable j means a designated number of the XML-Msg. After taking out one XML-Msg, a vector S(e)ⱼ having the same components as a vector S(s) is obtained from the items defined as SLA information about the XML-Msg.

After that, for the XML-Msg taken out in Step S241, the analysis module unit 16 obtains an Xpath vector expression M(e)_{k, l, j} which takes a value made by performing character string conversion to the value of the element and the attribute value included in the XML-Msg 43 as a component value of a hexadecimal expression (Step S242). Here, Xpath vector expression M(e)_{k, l, j} before division has the same components as the above-mentioned M(s)_{k=0, 1=1}.

Then, the analysis module unit 16 obtains a vector indicated in the following formula (1) (Step S243). The first component of the formula (1) is being expressed by: the XML-Msg 43 that is the reference message; and an inner product value of the vector which standardizes the similarity on the XML-Msg structure taken out newly, and the more proximate values they have, the more its value approaches 1. On the other hand, the second component of the formula (1) is being expressed by: the XML-Msg 43 that is the reference message; and an inner product value of the vector which is also standardized by the items defined as SLA information indicated by the XML-Msg taken out newly and a degree of similarity about a result. This value means that the more it approaches 1, the more similar tendency they have.

$$\begin{matrix}[ Formula , 1 ] & \\ ( \begin{matrix}\frac{( {M ( s )}_{k , j} \cdot {M ( e )}_{k , l , j} )}{‖ {M ( s )}_{k , j} ‖ \cdot ‖ {M ( e )}_{k , l , j} ‖} , \\ \frac{( {S ( s )}_{k , j} \cdot {S ( e )}_{j , k , l} )}{‖ {S ( s )}_{k , l} ‖ \cdot ‖ {S ( s )}_{k , l , j} ‖}\end{matrix} ) & ( 1 )\end{matrix}$$

After that, the analysis module unit 16 determines whether processing of the formula (1) has been performed to all of the XML-Msg groups 18 and 18′ obtained in Step S203 on that occasion (Step S244). When not performed (step S244/No), the analysis module unit 16 increments a numerical value of variable j (Step S245) and repeats Steps S241-S244 targeting the next XML-Msg.

When already performed (step S244/Yes), the analysis module unit 16 moves to processing of Step S246.

Then, the analysis module unit 16 performs sorting in descending order based on the first components among the formula (1)s calculated for the XML-Msg groups 18 and 18′ obtained in Step S203 (Step S246). The analysis module unit 16 takes out top k of them. The k of them taken out may be designated by the analysis time managing unit 13.

The analysis module unit 16 calculates and judges a correlation strength between the first components and the second components using k expressions of the formula (1) (Step S247). By this, the analysis module unit 16 finishes processing of Step S204.

The analysis module unit 16 caries out the processing of Step S204 for the number of divisions L designated. The number of divisions L is a designated function which divides the above-mentioned Xpath vector expressions M(e)_{k, l, j} and M(s)_{k=0, 1=1} in order to break them up for the purpose of identifying an expression form on the XML-Msg which causes a phenomenon having possibility of violating the items defined as SLA information more in detail. When a correlation strength is calculated by the formula (1) and judgment is made for each of all XML elements, the calculation amount is increased exponentially. For this reason, in this exemplary embodiment, the number of divisions L is designated so that calculation can stay within a calculation amount of a finite number. When processing corresponding to the number of divisions L has not been performed yet, the analysis module unit 16 designates the next divided part in Step S205 and repeats processing of Step S204. Meanwhile, in Xpath vector expression M(s)_{k=0, 1=1}, when “0” is assigned to the variable k and “1” is assigned to the variable 1, because it is an initial stage, the whole of the XML-Msgs is evaluation targets. Therefore, in this case, because it means a state without division, processing mentioned above is carried out only once.

When all processing of Step S204 is ended (step S205/Yes), the analysis module unit 16 performs sort in descending order from the most strong correlation value based on all correlation strengths corresponding to the number of divisions L obtained in Step S247 (Step S207).

The analysis module unit 16 judges a correlation strength in series (Step S208). Only values showing that a coefficient of correlation indicating a correlation strength is a specified value or is within an allowance are taken out.

When being less than the specified value (step S209/No), the analysis module unit 16 considers that there is no correlation in relation defined by the formula (1). For this reason, the analysis module unit 16 rejects evaluation of such no-correlation part and any further evaluation is not performed (Step S210).

When the granularity of the evaluation by the number of divisions L is rough, a case where the coefficient of correlation is less than a specified value might be expected. However, in this exemplary embodiment, processing of Step S210 is performed in order not to increase a calculation amount in the main procedure of coefficient of correlation shown in FIGS. 9 and 10 exponentially.

When all processing of Steps S208-S210 is ended (step S211/Yes), the analysis module unit 16 determines whether it is possible to subdivide it by the number of divisions L once again (Step S212). When subdivision is possible (step S212/Yes), the analysis module unit 16 merges Xpath vector expression M(e)_{k, l, j} and M(s)_{k, l} once again except for values which have been rejected. Then, the analysis module unit 16 generates M(e)_{k=k+1′, j} and M(s)_{k=k+1, 1′} which are new Xpath vector expressions (Step S213).

After that, the analysis module unit 16 subdivides M(e)_{k=k+1, 1′, j} and M(s)_{k=k+1, 1′} which are Xpath vector expressions by the number of divisions L (Step S214), and calls the subroutine procedure of correlation calculation once again for the first divided value (Step S215).

When subdivision is impossible (step S212/No), the analysis module unit 16 determines whether there is a value of a strong a correlation strength remaining not being rejected by Xpath vector expression M(e)_{k, l, j} and M(s)_{k, l} (Step S216).

When a value of high correlation strength exists (step S216/No), the analysis module unit 16 identifies absolute position information of a Xpath graph designated by the XML-Msg 43 of the message for reference and the related values thereof as a fact (Step S217) and finishes the main procedure of correlation calculation.

When a value of a high correlation strength does not exist (step S216/Yes), the analysis module unit 16 determines that a fact which falls under the category does not exist and finishes the main procedure of correlation calculation.

The outline of operation of the stream analyzing unit 2 is shown in FIG. 4. FIG. 4 shows a principle by which the circulating XML-Msg 34 between an arbitrary service provider and an arbitrary service requester is captured and whether an expression form included in the XML-Msg 34 violates the items defined as SLA information which indicate service providing conditions is judged by scanning.

The stream analyzing unit 2 scans expression forms included in the XML-Msg 34. For example, every time a tag <E31> and the like included in the XML-Msg 34 is designated,

a combination 30 of “/root/E11/E21/E31 [1]” which is absolute position information of a Xpath graph and its value “D1”,

a combination 31 of “/root/E11/E21/E31 [2]” and its value “D2”, and

a combination 32 of “/root/E11/E21/E31 [3]” and its value “D3”

are passed over by the stream analyzing unit 2.

In every such passing over, the stream analyzing unit 2 calls the fact index unit 4 according to the combinations 30, 31 and 32 and issues a fact inquiry 35.

Each time the fact index unit 4 receives the fact inquiry 35, it refers to its inside and replies with a fact result 36. When a reply including information to the effect that it is being registered is made by the fact result 36, the stream analyzing unit 2 starts the warning unit 3. As a result, the warning message 19 is issued immediately.

There exists a case where it is inefficient to make a fact inquiry by calling the fact index unit 4 according to the combination 30, 31 and 32. In such cases, the fact inquiry 35 is performed by calling the fact index unit in a way that “/root/E11/E21/E31 [1]” which is absolute position information on a Xpath graph is generalized as “/root/E11/E21/E31 [*]”.

As a result, it is possible that only a registered value “D1” is returned in the fact result 36 to be judged in the stream analyzing unit 2. In this case, the fact inquiry 35 that calls the fact index unit 4 is performed once for “/root/E11/E21/E31 [*]” which is absolute position information of a Xpath graph. After that, the fact inquiry 35 is not performed until “/root/E12/E22” from when a current expression of absolute position information on a Xpath graph changes. As a result, it is possible to process efficiently.

Meanwhile, the above-mentioned exemplary embodiment is an example of preferable implementation of the present invention, and the present invention is not limited to this exemplary embodiment.

For example, in the above-mentioned exemplary embodiment, it has been indicated taking a case where a message from a terminal of a service requester to a terminal of a service provider is captured as an example. However, also in a case where a message from a terminal of a service provider to a terminal of a service requester is captured, processing similar to the above should simply be performed.

Thus, various modifications are possible in the present invention.

This application claims priority based on Japanese application Japanese Patent Application No. 2008-081000, filed on Mar. 26, 2008, the disclosure of which is incorporated herein in its entirety.

### BRIEF DESCRIPTION OF DRAWINGS

FIG. 1 is a diagram showing a structure of a device for analyzing service response performance according to the present invention.

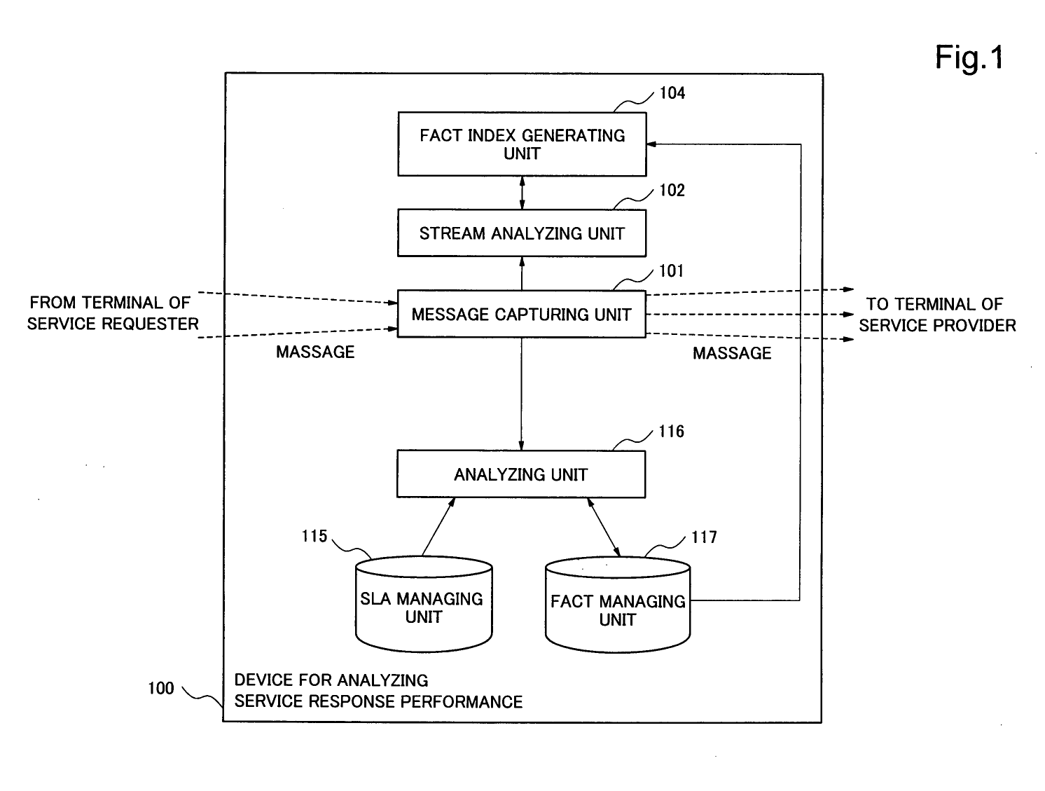

FIG. 2 is a diagram showing a structure of a service response performance analyzing system according to the preferred embodiment of the present invention.

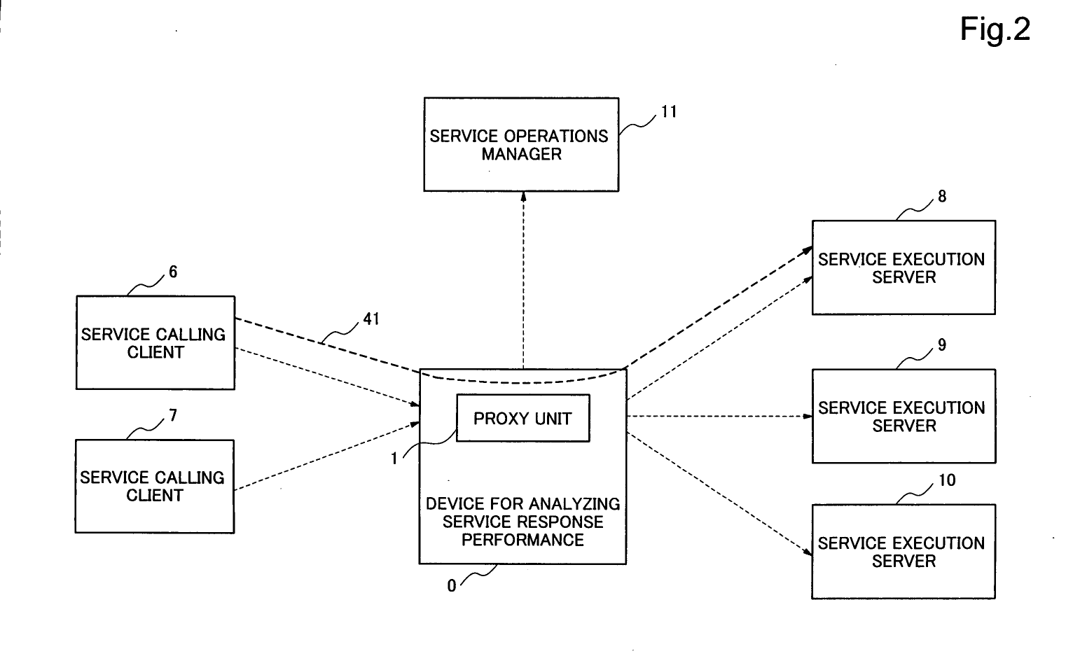

FIG. 3 is a diagram showing a structure of a device for analyzing service response performance

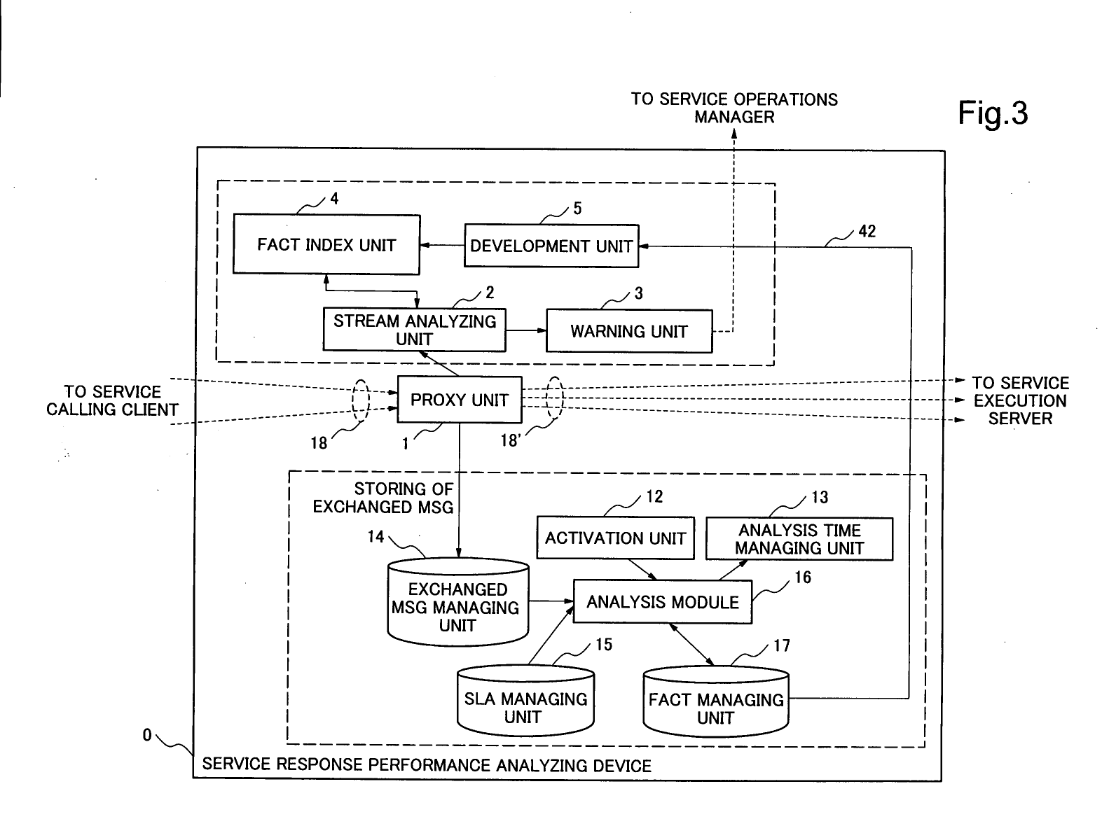

FIG. 4 is a diagram showing a procedure in which a stream analyzing unit refers to a fact index unit at the time of scanning.

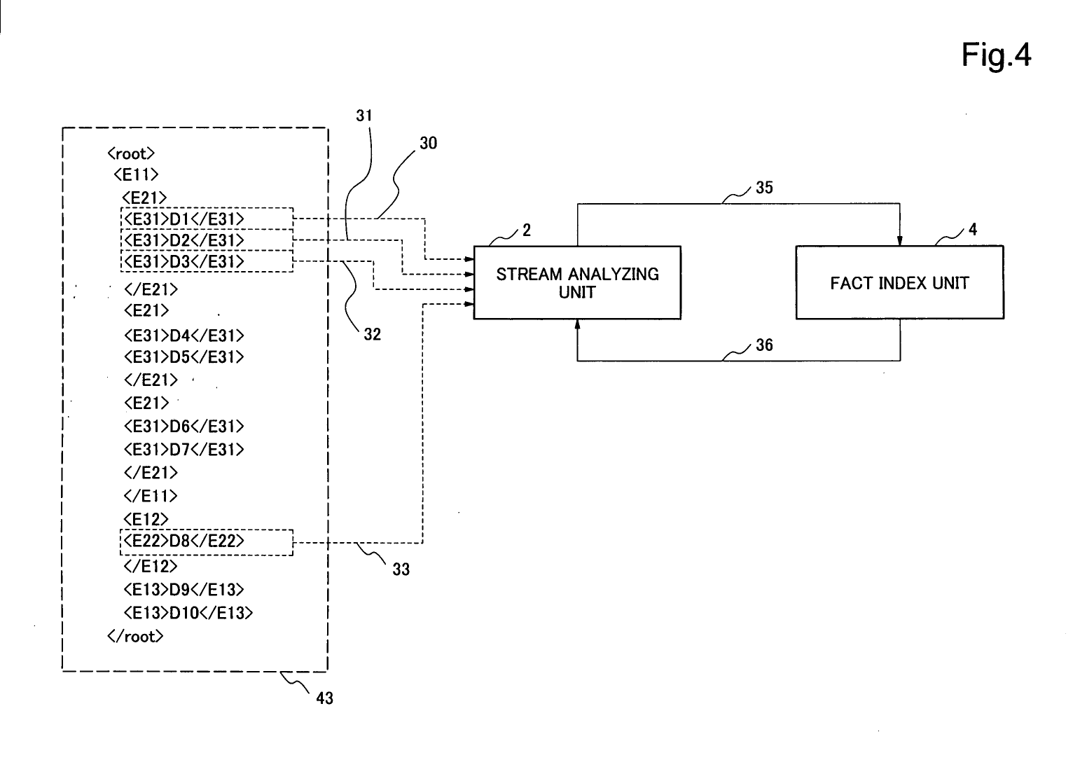

FIG. 5 is a diagram showing a conversion process carried out in an analysis module unit or conversion process carried out at the time of scanning.

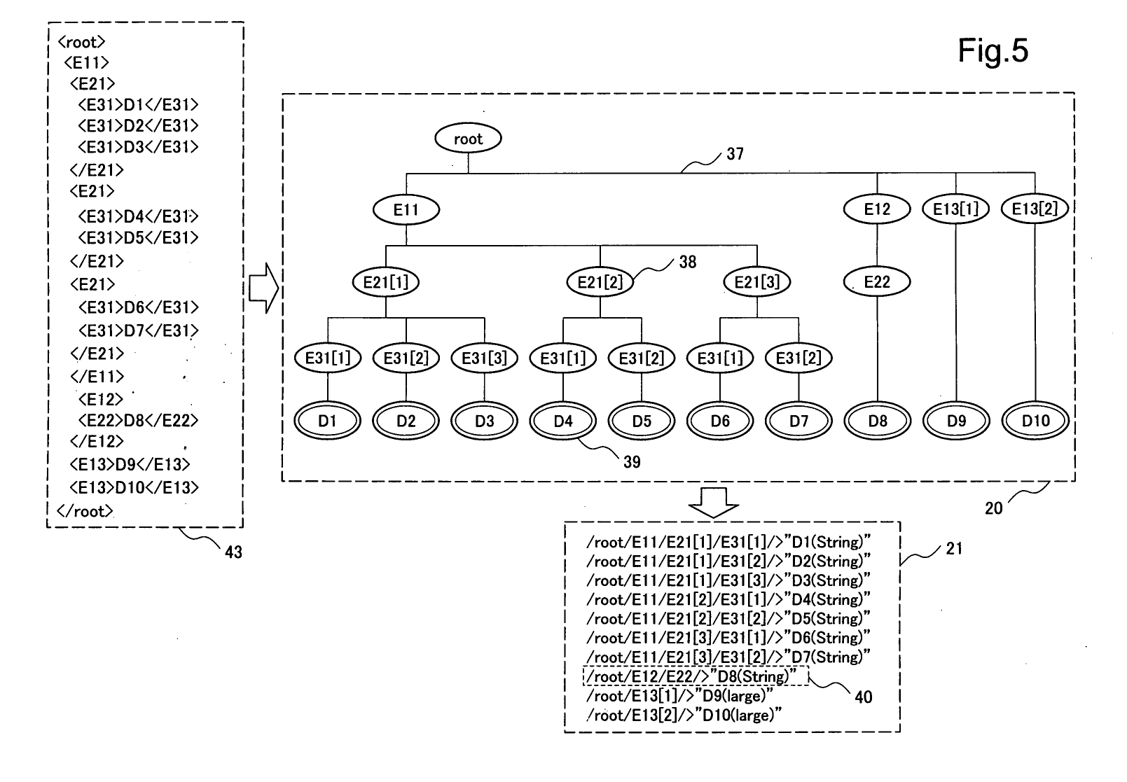

FIG. 6 is a diagram showing conversion processing performed by an analysis module unit at the time of registration of a fact.

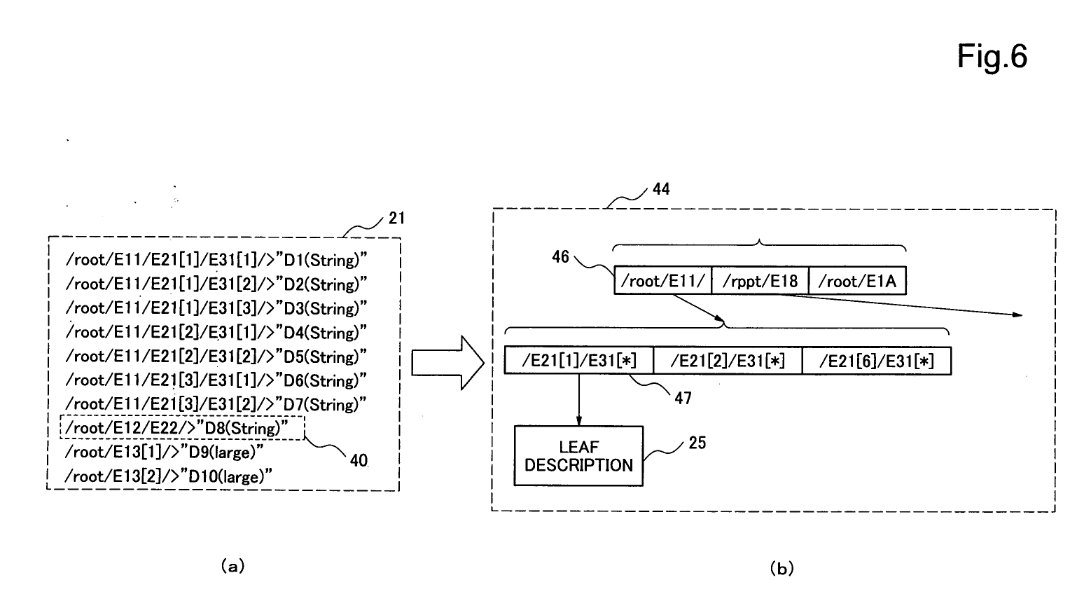

FIG. 7 is a diagram showing a schematic configuration of a fact index unit.

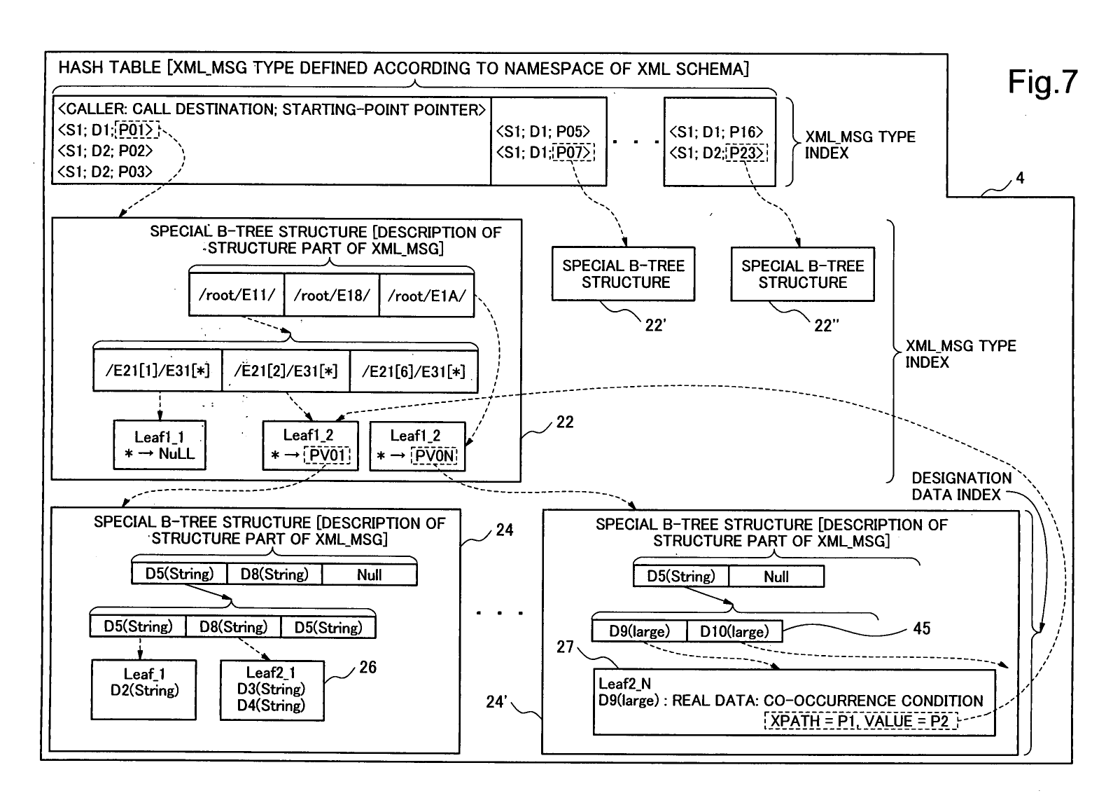

FIG. 8 is a diagram showing the main procedure of analysis and estimation.

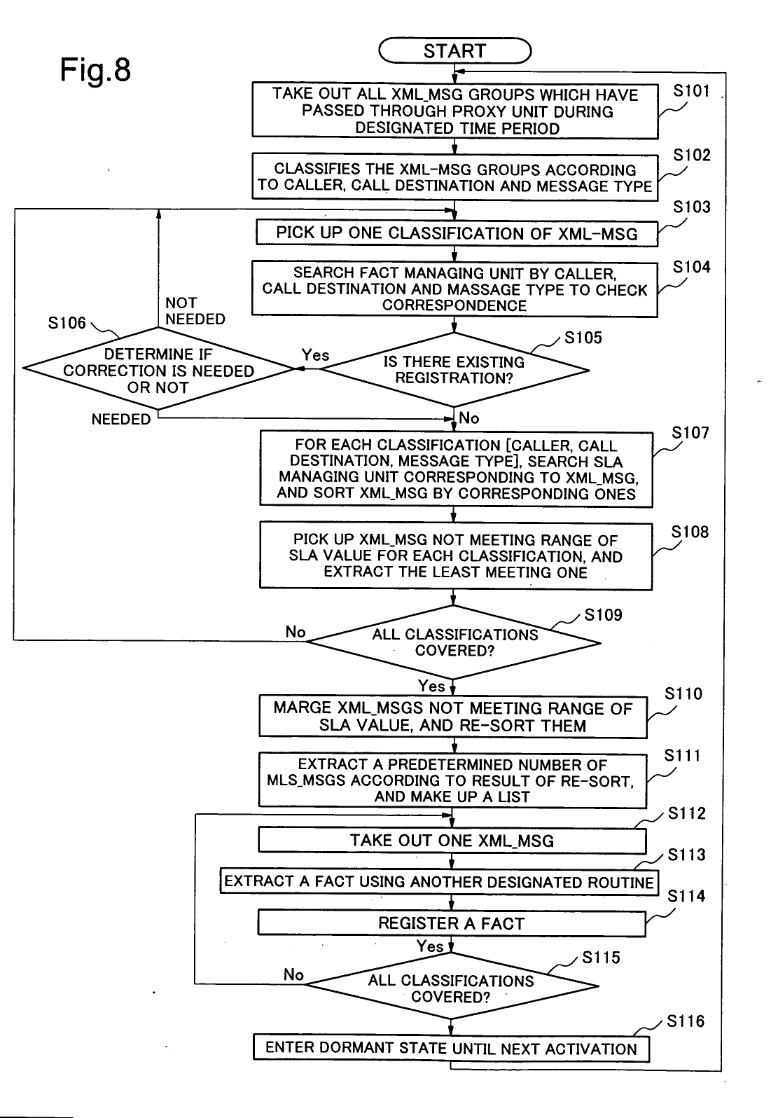

FIG. 9 is a diagram showing the main procedure of correlation calculation.

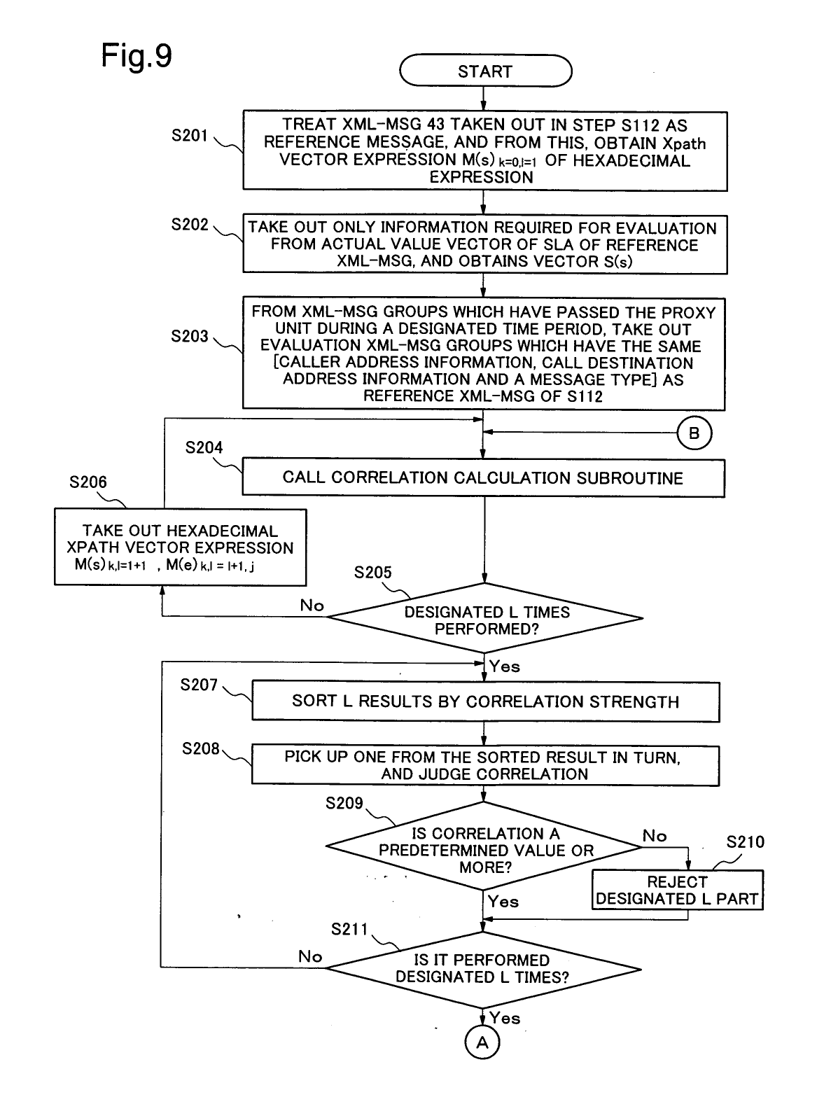

FIG. 10 is a diagram showing the main procedure of correlation calculation.

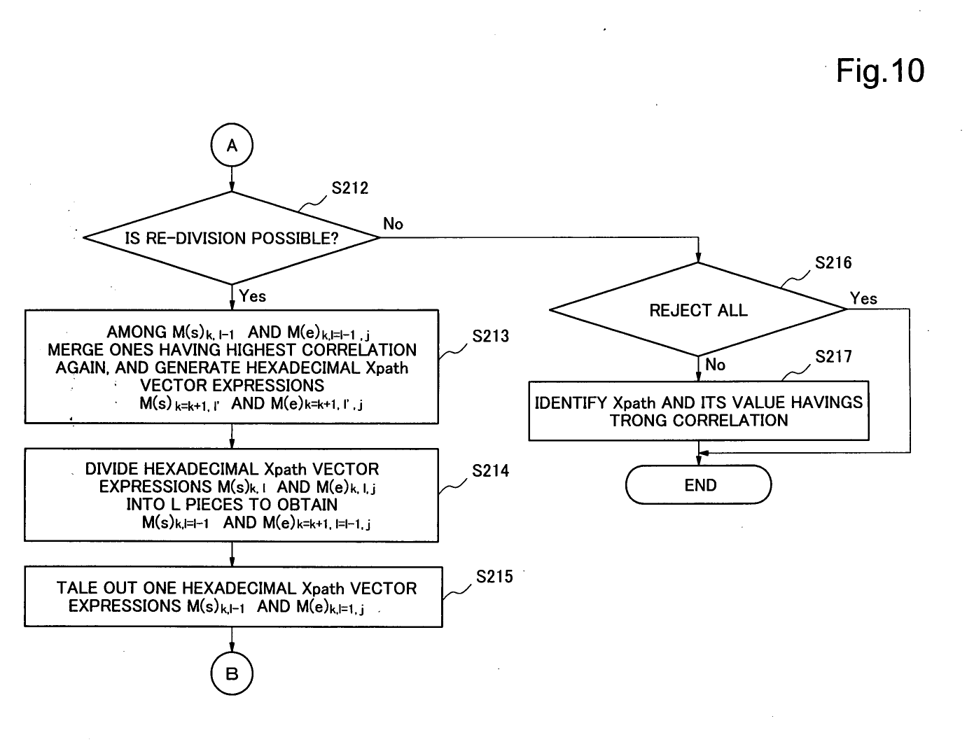

FIG. 11 is a diagram showing a subroutine procedure of correlation calculation.

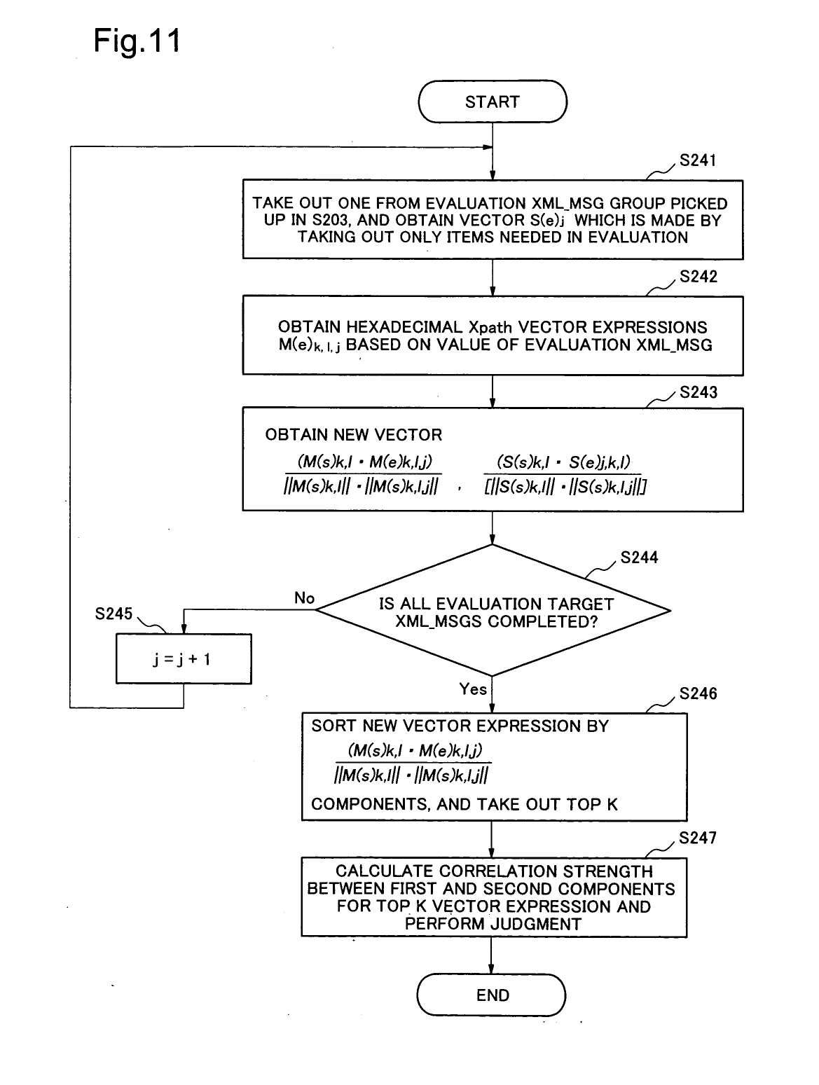

### REFERENCE SIGNS LIST

0, 100 device for analyzing service response performance

1 Proxy unit

2 Stream analyzing unit

3 Warning unit

4 Fact index unit

5 Development unit

6, 7 Service calling client

8, 9, 10 Service execution servers

11 Service operations manager

12 Activation unit

13 Analysis time managing unit

14 Exchanged Msg managing unit

15 SLA managing unit

16 Analysis module

17 Fact managing unit

18, 18′ Circulating XML-Msg groups 18 and 18′

19 Warning message

20 Equivalent Xpath graphic expression

21 Equivalent Xpath expression

22, 22′, 22″ XML-Msg structure indexes

23 XML-Msg type index

24, 24′ designation data indexes having B-Tree structure

25, 26 Leaf description

27 Co-occurrence condition description

30 Combination information of “/root/E11/E21/E31 [1]” and its value “D1”

31 Combination information of “/root/E11/E21/E31 [2]” and its value “D2”

Combination information of “/root/E11/E21/E31 [3]” and its value “D3”

34, 43 XML-Msg

35 Fact inquiry

36 Fact result

37 Link symbol

38 Node symbol

39 Leaf symbol

40 New character string

41 Service call relationship

42 Update information

44 Special B-Tree structure

45 Node hierarchy

46 Node (parent node) on B-Tree structure

47 Node (child node) on B-Tree structure

101 Message capturing unit

102 Stream analyzing unit 102

104 Fact index generating unit

115 SLA managing unit

116 Analyzing unit

117 Fact managing unit

1. A device for analyzing service response performance, comprising:
an SLA managing unit that manages, under an environment where plural terminals between both arbitrary service providers and arbitrary service requesters communicate, items defined as SLA information which indicate service providing conditions decided between the arbitrary service provider and the arbitrary service requester;
a message capturing unit that captures all communication messages which circulate between terminals of both of the arbitrary service provider and a terminal of the arbitrary service requester;
an analyzing unit that not only determines whether a communication message which the message capturing unit has captured relates to violations on the items defined as SLA information managed by said SLA managing unit or not, but also detects and identifies an expression form in the communication message which causes violation when the violation happens;
a fact managing unit that manages the violation-causing expression form detected and identified by said analyzing unit as a fact;
a stream analyzing unit that determines whether a fact corresponding to causing a violation against the items defined as SLA information exists or not by scanning the expression form included in the communication message which circulates between terminals of both of the arbitrary service provider and a terminal of the arbitrary service requester; and
a fact index generating unit that receives a series of the facts from said fact managing unit, and generates a fact index which said stream analyzing unit uses in order to perform processing of the scanning at a high speed.

2. The device for analyzing service response performance according to claim 1, comprising:
a warning unit that warns when finding that a fact which violates the items defined as SLA information exists as a result of the scanning by said stream analyzing unit.

3. The device for analyzing service response performance according to claim 1, further comprising:
an analysis time managing unit that measures processing time of one time of said analyzing unit, and performs at least one of adjustment of a time interval when said analyzing unit is started and change of a definition of an internal process of said analyzing unit to adjust processing by said analyzing unit such that the processing completes within a predetermined time.

4. The device for analyzing service response performance according to claim 1, wherein:
said analyzing unit performs analysis, when the communication message is written in XML, using a standardized inner product value which is calculated based on a Xpath vector expression which takes absolute position information of a Xpath graph based on XML Schema which describes a structure of the communication message as a component and a value which is made by performing character string conversion to a value of an element and an attribute value included in the communication message as a component value expressed in hexadecimal, and a vector expression about the items defined as SLA information related to the communication message, and a vector expression constituting a part of the Xpath vector expression.

5. The device for analyzing service response performance according to claim 1, wherein:
the fact index includes an index structure of three levels, and in a part of the index structure, a B-Tree structure of a structure where a part with a same character string as a parent node is omitted from description of a child node is adopted.

6. A recording medium that stores a service response performance analyzing program for making, under an environment where plural terminals between both arbitrary service providers and arbitrary service requesters communicate, an information processing apparatus placed between a terminal of the arbitrary service provider and a terminal of the arbitrary service requester analyze service response performance, the program making a computer which controls the information processing apparatus function as:
an SLA managing managing unit that manages items defined as SLA information which specify service providing conditions decided between the arbitrary service provider and the arbitrary service requester;
a message capturing unit that captures all communication messages which circulate between terminals of both of the arbitrary service provider and a terminal of the arbitrary service requester;
an analyzing not only unit that determines whether a communication message which the message capturing unit has captured relates to violations on the items defined as SLA information managed by said SLA managing unit or not, but also detects and identifies an expression form in the communication message which causes violation when the violation happens;
a fact managing unit that manages the violation-causing expression form detected and identified by said analyzing unit as a fact;
a stream analyzing unit that determines whether a fact corresponding to causing a violation against the items defined as SLA information exists or not by scanning the expression form included in the communication message which circulates between terminals of both of the arbitrary service provider and a terminal of the arbitrary service requester; and
a fact index generating unit that receives a series of the facts from said fact managing unit, and generates a fact index which said stream analyzing unit uses in order to perform processing of the scanning at a high speed.

7. The recording medium that stores the service response performance analyzing program according to claim 6, wherein the program makes the computer function as
a warning unit that warns when finding that a fact which violates the items defined as SLA information exists as a result of the scanning by said stream analyzing unit.

8. The recording medium that stores the service response performance analyzing program according to claim 6, wherein the program
makes the computer further function as
an analysis time managing unit that measures processing time of one time of said analyzing unit, and performs at least one of adjustment of a time interval when said analyzing unit is started and change of a definition of an internal process of said analyzing means unit to adjust processing by said analyzing unit such that the processing completes within a predetermined time.

9. The recording medium that stores the service response performance analyzing program according to claim 6, wherein
said analyzing unit performs analysis, when the communication message is written in XML, using a standardized inner product value which is calculated based on a Xpath vector expression which takes absolute position information of a Xpath graph based on XML Schema which describes a structure of the communication message as a component and a value which is made by performing
character string conversion to a value of an element and an attribute value included in the communication message as a component value expressed in hexadecimal, and a vector expression about the items defined as SLA information related to the communication message, and a vector expression constituting a part of the Xpath vector expression.

10. The recording medium that stores the service response performance analyzing program according to claim 6 wherein
the fact index includes an index structure of three levels, and in a part of the index structure, a B-Tree structure of a structure where a part with a same character string as a parent node is omitted from description of a child node is adopted.

11. (canceled)

12. A service response performance analyzing method for analyzing, under an environment where plural terminals between both arbitrary service providers and arbitrary service requesters communicate, service response performance by an information processing apparatus placed between a terminal of the arbitrary service provider and a terminal of the arbitrary service requester, wherein
the information processing apparatus:
manages items defined as SLA information which indicates service providing conditions decided between the arbitrary service provider and the arbitrary service requester;
captures all communication messages which circulate between terminals of both of the arbitrary service provider and a terminal of the arbitrary service requester;
determines whether a communication message which has been captured relates to violations on the items defined as SLA information which are managed or not, and detects and identifies an expression form in the communication message which causes violation when the violation happens;
manages the violation-causing expression form detected and identified which causes the violation as a fact;
determines whether a fact corresponding to causing a violation against the items defined as SLA information exists or not by scanning an expression form included in the communication message which circulates between terminals of both of the arbitrary service provider and a terminal of the arbitrary service requester; and
receives the fact, and generates a fact index in order to perform processing of the scanning at a high speed.

13. The service response performance analyzing method according to claim 12, wherein
the information processing apparatus
warns when finding that a fact which violates the items defined as SLA information exist as a result of the scanning.
